(19) United States
(12) Patent Application Publication
(10) Pub. No.: US 2014/0210943 A1
(43) Pub. Date: Jul. 31, 2014

(54) APPARATUS AND METHOD FOR CREATING THREE-DIMENSIONAL VIDEO

(71) Applicant: Electronics and Telecommunications Research Institute, Daejeon-si (KR)

(72) Inventors: Hye-Sun KIM, Daejeon-si (KR); Yun-Ji BAN, Daejeon-si (KR); Kyung-Ho JANG, Daejeon-si (KR); Hae-Dong KIM, Daejeon-si (KR); Jung-Jae YU, Seongnam-si Gyeonggi-do (KR); Myung-Ha KIM, Daejeon-si (KR); Joo-Hee BYON, Daejeon-si (KR); Ho-Wook JANG, Daejeon-si (KR); Seung-Woo NAM, Daejeon-si (KR)

(73) Assignee: Electronics and Telecommunications Research Institute, Daejeon-si (KR)

(21) Appl. No.: 13/973,527

(22) Filed: Aug. 22, 2013

(30) Foreign Application Priority Data
Jan. 31, 2013 (KR) 10-2013-0011404

(51) Int. Cl. H04N 13/00

(52) U.S. Cl. CPC H04N 13/0022
USPC 348/43

(57) ABSTRACT

An apparatus for creating a three dimensional video including a cut split unit configured to split an input two-dimensional video into two or more cuts based on a predetermined reference, a manual conversion unit configured to receive a depth value of one of frames that form each of the two or more cuts split by the cut split unit and convert the one frame into a three dimensional form, and an automatic conversion unit configured to convert other frames included in the cuts with reference to the one frame, which is converted into the three dimensional form by the manual conversion unit, into a three dimensional form.

### CROSS-REFERENCE TO RELATED APPLICATION

This application claims the benefit under 35 U.S.C. §119(a) of Korean Patent Application No. 10-2013-0011404, filed on Jan. 31, 2013, in the Korean Intellectual Property Office, the entire disclosure of which is incorporated herein by reference for all purposes.

### BACKGROUND

1. Field

The following description relates to an apparatus and method for creating a three-dimensional video, and more particularly, to an apparatus and method for converting a two-dimensional video into a three-dimensional video by use of combination of an automatic conversion and a manual conversion.

2. Description of the Related Art

A human can perceive depth sensation of an object by transmitting different images that are viewed by a left side eye and a right side eye at different positions, respectively, to the brain of the human, and the brain perceives the depth of the object based on a difference in phase between the two images input from the left side eye and the right side eye. Accordingly, when three-dimensional content is created, an image viewed by a left side eye and an image viewed by a right side eye need to be created in pairs.

A method of creating a left eye image and a right eye image includes a manual conversion method and an automatic conversion method.

The manual conversion method is achieved as an operator directly separates objects one by one from a two-dimensional image, assigns a depth value to the separated individual object, and then performs a re-rendering with both side eyes. Such a manual conversion is achieved by checking with the naked eye one by one, and thus a three-dimensional image has a quality that may vary with time and efforts. However, such a manual conversion method needs to separate a plurality of objects from each frame and assign a depth value, and thus a great amount of workforce and time are required. This increases manufacturing costs so that the manual conversion may be applied only to a commercial movie or large scale content. In addition, such a manual conversion is performed by only the workers who can use a high-end S/W.

Meanwhile, the automatic conversion method creates a three-dimensional image in batches through an automatic conversion algorithm that has been already developed, so that a great amount of three-dimensional content can be simply and rapidly produced in real time. Most of the automatic conversion methods developed up to now are achieved by mounting a chip on a 3DTV or a conversion H/W such that the three-dimensional content is provided in real time at any time. However, when the three-dimensional content is manufactured using such an automatic conversion method, the frequency of error occurrence is high due to the limitation of the algorithm, and thus the quality of the three-dimensional content stays below a predetermined level. That is, a user needs to be satisfied only with the quality level in which a three-dimensional sensation is temporally provided.

For this reason, general users only enjoy three-dimensional content that is converted by a high-salary technician, or views low quality three-dimensional content produced by an automatic three-dimensional conversion H/W. Accordingly, even in the trend of user-created content (UCC) becoming popular, the three-dimensional content is regarded as an inaccessible field for users, and the interest in the three-dimensional content decreases.

### SUMMARY

The following description relates to an apparatus and method that are capable of enabling a general user to create high quality three-dimensional content in an easy and rapid manner.

Other features and aspects will be apparent from the following detailed description, the drawings, and the claims.

### BRIEF DESCRIPTION OF THE DRAWINGS

FIG. 1 is a structure diagram illustrating a configuration of a two-dimensional video.

FIG. 2 is a block diagram illustrating an apparatus for creating a three-dimensional video in accordance with an example embodiment of the present disclosure.

FIG. 3 is a drawing illustrating a cut split in accordance with an example embodiment of the present disclosure.

FIGS. 4A to 4E are drawings illustrating a manual conversion.

FIG. 5 is a drawing illustrating an automatic conversion in accordance with an example embodiment of the present disclosure.

FIG. 6 is a flowchart showing a method of creating a three-dimensional video in accordance with an example embodiment of the present disclosure.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness. In addition, terms described below are terms defined in consideration of functions in the present invention and may be changed according to the intention of a user or an operator or conventional practice. Therefore, the definitions must be based on contents throughout this disclosure.

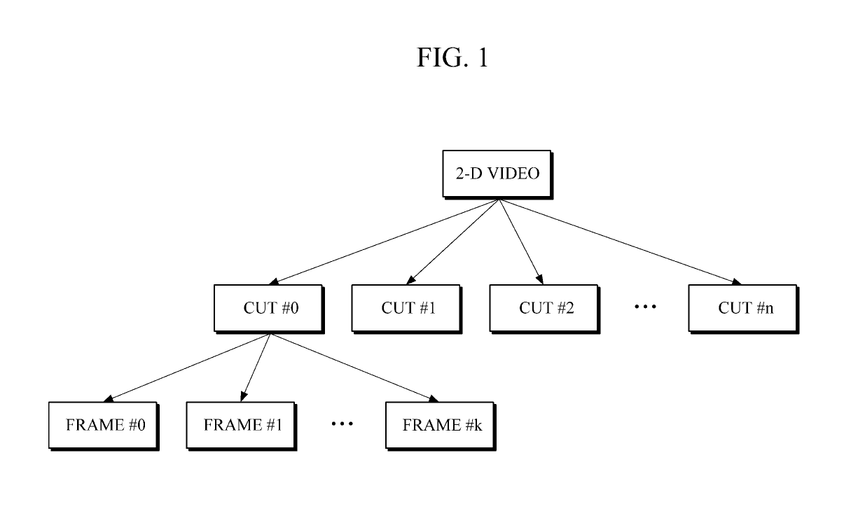

FIG. 1 is a structure diagram illustrating a configuration of a two-dimensional video.

Referring to FIG. 1, a video is formed of a plurality of successive still image frames, and each of the still image frames has a similar three-dimensional depth value unless an inside object significantly moves back and forth of a scene. The still image frames having a similar object and a similar depth value may be divided into cuts. Accordingly, as shown in FIG. 1, the video consists of two or more cuts (n+1), and each of the cuts consists of two or more (k+1) frames each having a similar object and a similar depth value.

The present disclosure, in consideration of that frames constituting each cut have similar depth values, if a three dimension depth value of one of frames belonging to the same cut is edited, other frames can be edited with reference to the three dimension depth value of the edited frame so that the work of a user is minimized. That is, the quality is improved by enabling a user to convert one of the frames into a three dimensional form, and the working speed and time is reduced by automatically converting the remaining frames.

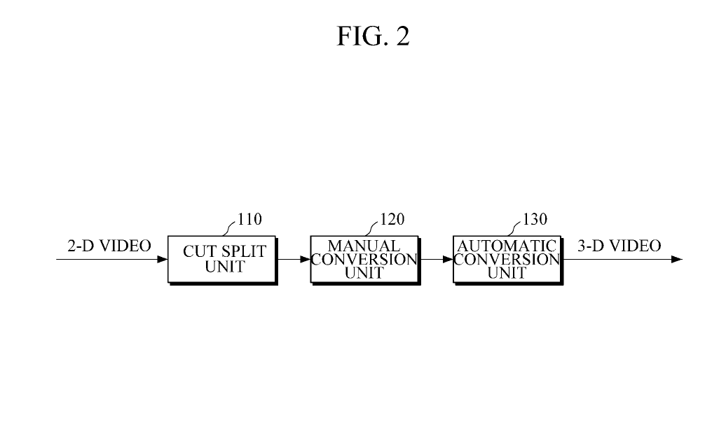

FIG. 2 is a block diagram illustrating an apparatus for creating a three-dimensional video in accordance with an example embodiment of the present disclosure.

Referring to FIG. 2, an apparatus for creating a three-dimensional video includes a cut split unit 110, a manual conversion unit 120, and an automatic conversion unit 130.

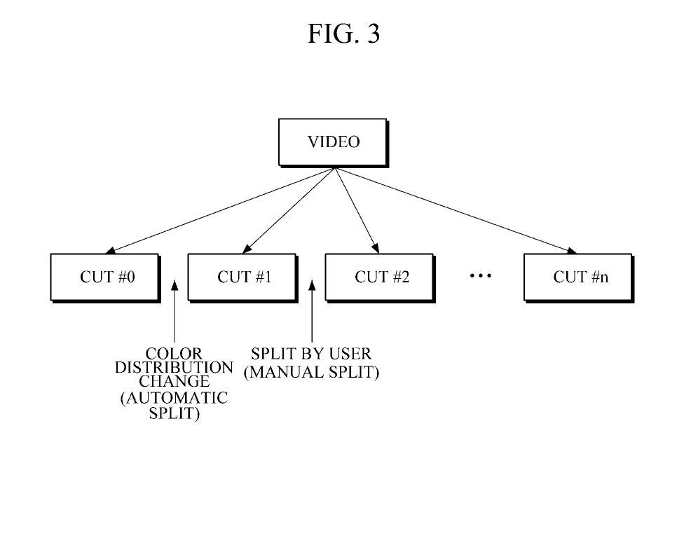

The cut split unit 110 splits an input two-dimensional video into two or more cuts based on a predetermined reference. A method of splitting the video into cuts by the cut split unit 110 is implemented by various example embodiments. This will be described with reference to FIG. 3.

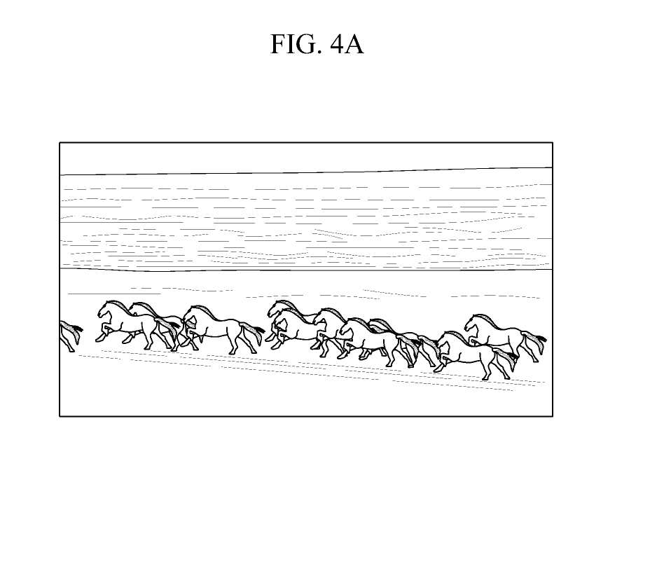

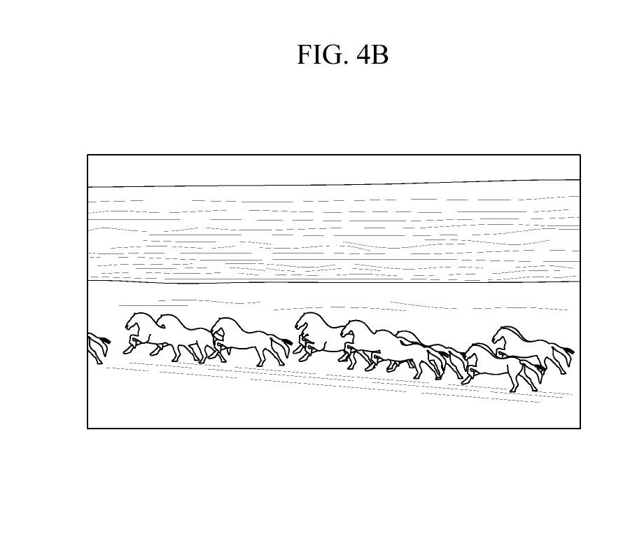

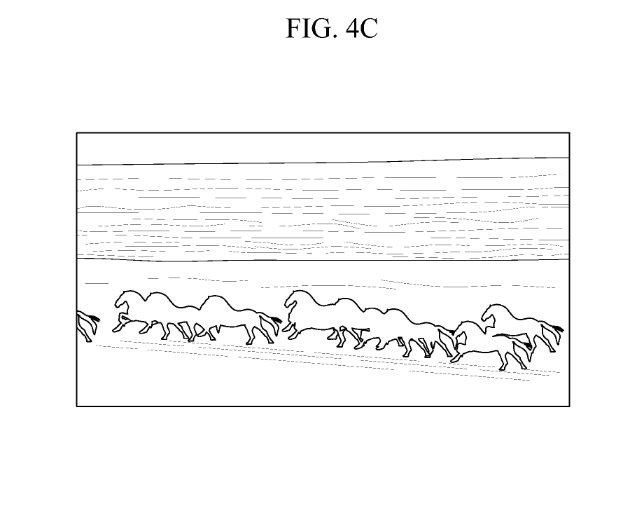

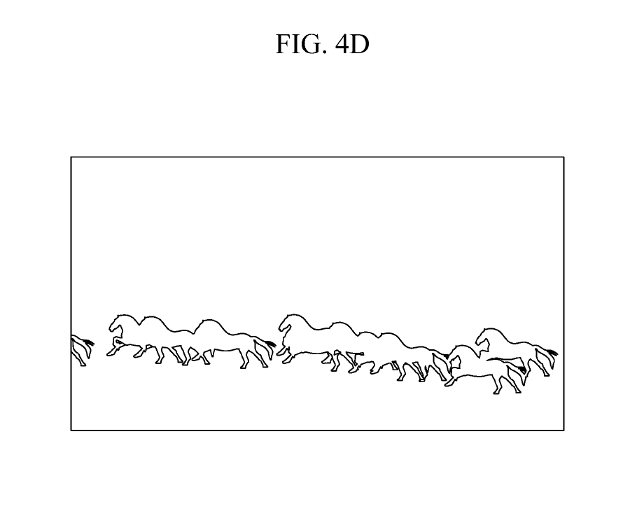

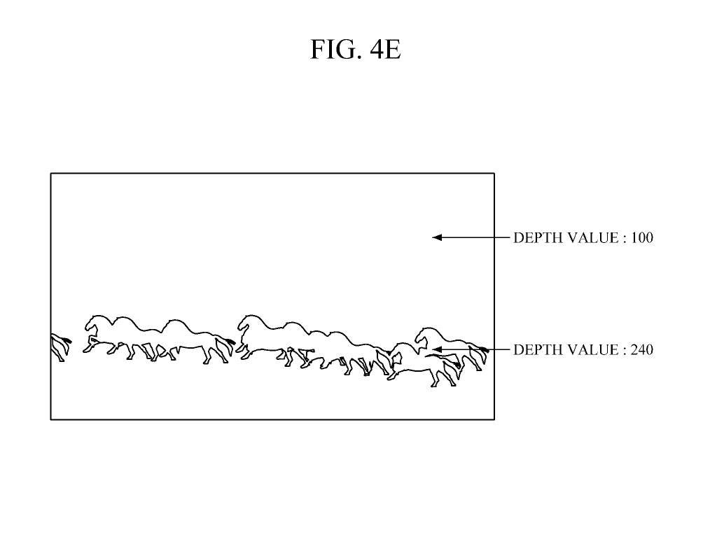

The manual conversion unit 120 receives a depth value of one of frames that form each of the two or more cuts split by the cut split unit 110, and converts the frame into a three dimensional form. In accordance with an example embodiment, the one frame may be the first frame among the frames forming the cut. In addition, the manual conversion unit 120 may receive the depth value from a user in units of color segments forming a single image frame. In addition, the manual conversion unit 120, in a case in which the same object is split into two or more different segments, may merge the two or more segments. This will be described with reference to FIGS. 4A to 4E later. In addition, the manual conversion unit 120 may receive a parameter that adjusts a degree of splitting segments from a user, and sets the degree of splitting the segment.

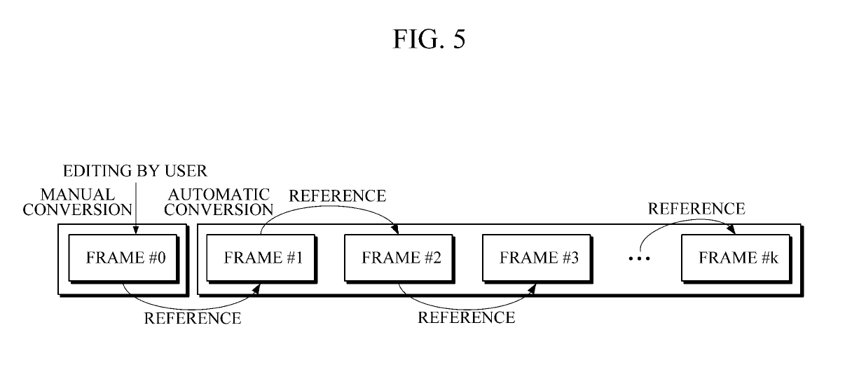

The automatic conversion unit 130 converts other frames included in the cuts with reference to the frame, which is converted into the three dimensional form by the manual conversion unit 120, into a three dimensional form. This will be described with reference to FIG. 5.

FIG. 3 is a drawing illustrating a cut split in accordance with an example embodiment of the present disclosure.

Referring to FIG. 3, the cut splitting may be achieved by an automatic splitting or a manual splitting.

In accordance with an example embodiment of the present disclosure, the cut split unit 110 automatically splits a video in a case in which a color variation value of successive frames forming the video is a predetermined threshold value or above. Since frames forming the same cut have similar color distributions to each other, the video may be automatically split based on a point at which color distribution information of the successive frames is greatly changed.

In accordance with another aspect of the present disclosure, the cut split unit 110 provides a user interface, and splits the video according to user cut split information that is input through the user interface. That is, in order for a user to produce a three dimensional sensation, the cut split unit 110 may provide the user interface that enables the user to clip or merge cuts.

FIGS. 4A to 4E are drawings illustrating a manual conversion.

The manual conversion unit 120 supports a user editing work for a three-dimensional video conversion, and allows the user editing to be performed in units of color segments.

The color segment represents information grouping regions that have similar color values in an image, and the manual conversion unit 120 may create a color segment image shown in FIG. 4B from one original image frame shown in FIG. 4A. That is, a region having a small color variation is converted with one color value. Such a frame segment image may serve as object information of an image since regions of the frame segment image are divided in units of objects or in units of object details in most cases.

In order that a user performs editing in units of color segments, the manual conversion unit 120 allows a color segment (as shown in FIG. 4C) to be selected among a plurality of color segments, and receives a depth value of the segment image from the user. The color segment in an image is a set of pixel images that have similar color values in the image. For example, if a user clicks a desired color segment region with a mouse, the segment is selected.

In a case in which the same object is split into different segments since the object has different color values, the segment regions may be merged as shown in FIG. 4D. For example, pixels having different color values based on a color segment algorithm are split into different color segmentations A and B. However, as the user simultaneously selects the segments A and B, and executes a menu ‘merge’, the segments even with different colors may be merged into one segment.

Referring to FIG. 4E, depth values are assigned to the segment image merged as the above.

In addition, it is impossible to split one segment into a plurality of segments, but a parameter may be designated so as to split the segments more minutely during an image segmentation process.

FIG. 5 is a drawing illustrating an automatic conversion in accordance with an example embodiment of the present disclosure.

The automatic conversion unit 130, as a frame #0 is manually converted into a three dimensional form by user editing, automatically converts a frame #1 following the frame #0 with reference to segment region information and a depth value of the frame #0, and automatically converts a frame #2 with reference to segment region information and a depth value of the frame #1. That is, the automatic conversion unit 130 sequentially converts frames following the second frame, each frame converted with reference to segment region information and a depth value of a frame prior to the each frame.

The automatic conversion on FIG. 5 is illustrated only as an example of the present disclosure, and the present disclosure is not limited thereto. That is, the automatic conversion unit 130 may convert one of the remaining frames, regardless of the sequence, with reference to a frame that is edited by the manual conversion unit 120, and may convert another one of the remaining frames with reference to the one frame edited.

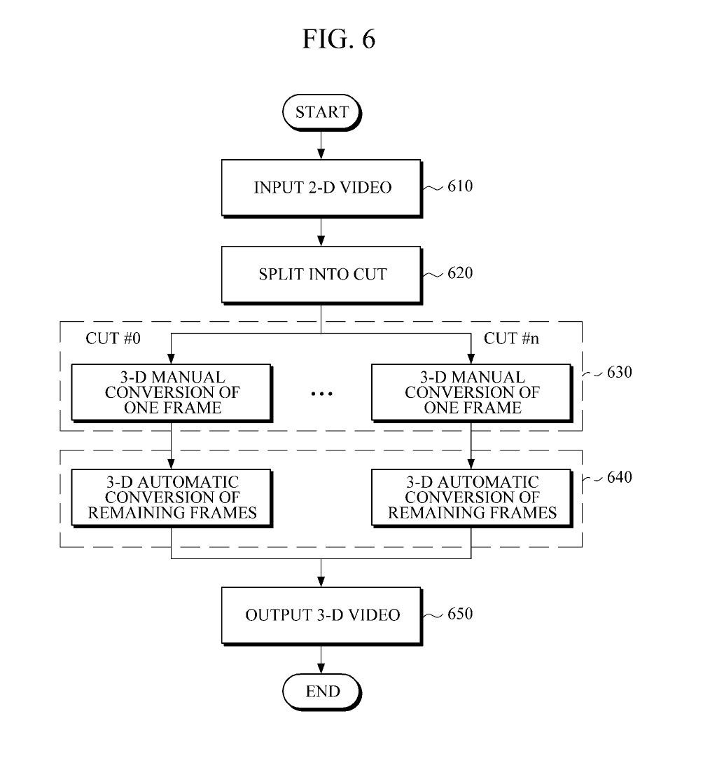

FIG. 6 is a flowchart showing a method of creating a three-dimensional video in accordance with an example embodiment of the present disclosure.

Referring to FIG. 6, a three-dimensional video creating apparatus, if a two-dimensional video is input in 610, splits the input two-dimensional video into two or more cuts based on a predetermined reference in 620. The cut splitting may be achieved by an automatic splitting or a manual splitting.

In accordance with an example embodiment of the present disclosure, the three-dimensional video creating apparatus automatically splits the video in a case in which a color variation value between successive frames forming the video is a predetermined threshold value or above. Since frames forming the same cut have similar color distributions to each other, the video may be automatically split based on a point at which color distribution information of the successive frames is greatly changed.

In accordance with another aspect of the present disclosure, the three-dimensional video creating apparatus provides a user interface, and splits the video according to user cut split information that is input through the user interface. That is, in order for a user to produce a three dimensional sensation, the user interface enabling the user to clip or merge cuts is provided.

The three-dimensional video creating apparatus receives a depth value of one of frames that form each of two or more split cuts (n+1), and manually converts the one frame into a three dimensional form in 630. In accordance with an example embodiment, the one frame may be the first frame among the frames forming the cut. In addition, the three-dimensional video creating apparatus may receive the depth value in units of color segments forming a single image frame. Here, the color segment represents information grouping regions having similar color values in an image, and the three-dimensional video creating apparatus may create a color segment image from one original image frame by converting a region having a small color variation with a color value. Such a frame segment image may serve as object information of an image since regions of the frame segment image are divided in units of objects or in units of object details.

In addition, in a case in which the same object is split into two or more different segments, the two or more segments may be merged. In addition, a parameter that adjusts a degree of splitting segments may be received from a user, and the degree of splitting segments may be set.

The three-dimensional video creating apparatus automatically converts other frames included in the cuts with reference to the frame, which is converted into the three dimensional form in 640.

In accordance with an example embodiment, the three-dimensional video creating apparatus, as a frame #0 is manually converted into a three dimensional form by user editing, automatically converts a frame #1 following the frame #0 with reference to segment region information and a depth value of the frame #0, and automatically converts a frame #2 with reference to segment region information and a depth value of the frame #1. That is, the three-dimensional video creating apparatus sequentially converts frames following the second frame, each frame converted with reference to segment region information and a depth value of a frame prior to the each frame.

The three-dimensional video creating apparatus outputs the three dimension video created by the manual conversion and the automatic conversion as the above in 650.

The present disclosures, in order to provide an easy tool that enables a general user to convert a two-dimensional video into a three-dimensional video, without performing a three dimension conversion on each frame of the video, splits a video in units of cuts and allows a user to edit one frame included in the cut, so that if one of frames included in the cut is edited, other frames are automatically converted, thereby simplifying the work of a user. In addition, a user directly produces a three dimensional sensation, thereby correcting an error of three dimension values that may be generated from an automatic conversion.

As is apparent from the present disclosure, the three-dimensional content is produced in an easy manner and thus the production of three-dimensional content can be increased, so that three dimension related industries having a difficulty due to a lack of content can also be activated.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for creating a three-dimensional video, the apparatus comprising:
a cut split unit configured to split an input two-dimensional video into two or more cuts based on a predetermined reference;
a manual conversion unit configured to receive a depth value of one of frames that form each of the two or more cuts split by the cut split unit, and convert the one frame into a three dimensional form; and
an automatic conversion unit configured to convert other frames included in the cuts into a three dimensional form with reference to the one frame, which is converted into the three dimensional form by the manual conversion unit.

2. The apparatus of claim 1, wherein the cut split unit automatically splits the video in a case in which a color variation value between successive frames forming the two-dimensional video is a predetermined threshold value or above.

3. The apparatus of claim 1, wherein the cut split unit provides a user interface, and splits the video according to user cut split information that is input through the user interface.

4. The apparatus of claim 1, wherein the manual conversion unit receives the depth value in units of color segments forming the one frame.

5. The apparatus of claim 1, wherein the manual conversion unit, in a case in which a same object is split into two or more different segments, merges the two or more segments.

6. The apparatus of claim 1, wherein the manual conversion unit receives a parameter that adjusts a degree of splitting segments from a user, and sets the degree of splitting the segments.

7. The apparatus of claim 1, wherein the automatic conversion unit converts one of remaining frames that are not converted by the manual conversion unit among the frames forming each of the two or more cuts, with reference to the frame converted by the manual conversion unit, and converts another one of the remaining frames with reference to the frame converted by the automatic conversion unit.

8. The apparatus of claim 1, wherein the manual conversion unit converts a first frame among the frames forming the cut into a three dimensional form.

9. The apparatus of claim 8, wherein the automatic conversion unit converts a second frame into a three dimensional form with reference to the first frame, and converts frames following the second frame into a three dimensional form, each of the frames converted with reference to a frame prior to the each frame.

10. A method of creating a three-dimensional video, the method comprising:
splitting an input two-dimensional video into two or more cuts based on a predetermined reference;
receiving a depth value of one of frames that form each of the two or more split cuts, and manually converting the one frame into a three dimensional form; and
automatically converting other frames included in the cuts into a three dimensional form with reference to the one frame, which is converted into the three dimensional form.

11. The method of claim 10, wherein in the splitting of the input two-dimensional video into two or more cuts, the video is automatically split in a case in which a color variation value between successive frames forming the two-dimensional video is a predetermined threshold value or above.

12. The method of claim 10, wherein in the splitting of the input two-dimensional video into two or more cuts, a user interface is provided and the video is split according to user cut split information that is input through the user interface.

13. The method of claim 10, wherein in the manually converting of the one frame into the three dimension, the depth value is received from a user in units of color segments forming the one frame.

14. The method of claim 10, wherein in the manually converting of the one frame into the three dimension, in a case in which a same object is split into two or more different segments, the two or more different segments are merged.

15. The method of claim 14, wherein in the manually converting of the one frame into the three dimension, a parameter that adjusts a degree of splitting segments is received from a user, and the degree of splitting the segments is set.

16. The method of claim 10, wherein in the automatically converting of other frames, one of remaining frames that are not manually converted among the frames forming each of the two or more cuts is converted with reference to the frame manually converted, and another one of the remaining frames is converted with reference to the frame automatically converted.

17. The method of claim 10, wherein in the manually converting of the one frame into the three dimension, a first frame among the frames forming the cut is converted into a three dimensional form.

18. The method of claim 17, wherein in the automatically converting of other frames, a second frame is converted into a three dimensional form with reference to the first frame, and frames following the second frame each is converted with respect to a frame prior to the each frame into a three dimensional form.
